(19) United States
(12) Patent Application Publication
(10) Pub. No.: US 2004/0120696 A1
(43) Pub. Date: Jun. 24, 2004

(54) System and method for storing data in a camcorder

(76) Inventors: Richard L. Solomon, Colorado Springs, CO (US); Steven Callicott, Colorado Springs, CO (US); David M. Weber, Moument, CO (US)

Correspondence Address: LSI LOGIC CORPORATION, 1621 BARBER LANE, MS: D-106 LEGAL, MILPITAS, CA, 95035, US

(21) Appl. No.: 10/326,331

(22) Filed: Dec. 19, 2002

(51) Int. Cl. H04N 5/76; H04N 5/225

(52) U.S. Cl. 386/117

(57) ABSTRACT

The present invention provides a system and method for utilizing a camcorder as a tape backup device for a computing system. A communicative link is established between a camcorder and a computing system which allows data from the computing system to be communicated to the camcorder. The data, once received by the camcorder, is stored in a storage medium of the camcorder.

### FIELD OF THE INVENTION

The present invention generally relates to the field of data storage, and particularly to a system and method for storing data in a camcorder.

### BACKGROUND OF THE INVENTION

Protecting the programs and data on a computer has become increasingly important as computer technology becomes more pervasive in everyday life. From the operating systems installed to the temporary files created users are typically confronted with the problem of ensuring that even in the event of total computer failure they are able to recapture critical programs and data.

One protection method being currently employed is to create a tape backup of programs and data stored on a computer. This method provides a complete copy of the hard drive of the computer, so in the event of total failure the tape backup may be used to re-install lost programs and data. Unfortunately, this method often requires the computer user to purchase numerous tape storage devices and even additional hardware devices in order to create these tape backups. The expense of such a method of tape backup may be prohibitive and result in computer users not being able to sufficiently protect themselves from losses.

It is also common for computer users to own a variety of other devices with computing systems. Unfortunately, connecting these computing systems with the computer may not allow the user to save information from the personal computer.

Therefore it would be desirable to provide a tape backup system which did not require a burdensome investment of money into additional resources and allowed a user to utilize their existing resources to save the information that is most valuable to them.

### SUMMARY OF THE INVENTION

Accordingly, the present invention is directed to a system and method of storing data in a camcorder. Camcorders are commonplace devices which may be owned by many users of computers. Camcorders provide an additional computing system that is often left untapped by other resources other than for the recording and display of audio and video images. Utilizing the computing system within the camcorder to provide a tape backup may eliminate costly new hardware acquisitions and provide a needed utility to computer users.

In a first aspect of the present invention, a data storage system includes a camcorder with a storage medium communicatively coupled to a computing system. The computing system is suitable for providing data to the camcorder. The data storage system further includes a computer readable instruction set which directs the camcorder to report as a storage device. Data received from the computing system to the camcorder is stored in the storage medium of the camcorder. In this manner the camcorder is enabled as a tape backup device for the computing system. The instruction set which directs the camcorder to report as a storage device may be loaded directly onto the camcorder or reside on the computing system. The instruction set may be specific to the particular camcorder being used or the instruction set may be implemented as a device driver on the computing system to report a variety of camcorders as storage devices to other applications on the computing system.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a system for storing data in accordance with an exemplary embodiment of the present invention;

FIG. 2 is a flowchart illustrating a method of storing data on a camcorder in accordance with an exemplary embodiment of the present invention;

FIG. 3 is a flowchart illustrating a method of storing data provided by a computing system in accordance with an exemplary embodiment of the present invention;

FIG. 4 is a flowchart illustrating a method of storing data in accordance with an exemplary embodiment of the present invention; and

FIG. 5 is a block diagram illustrating a computing system in accordance with an exemplary embodiment of the present invention.

### DETAILED DESCRIPTION OF THE INVENTION

Reference will now be made in detail to the presently preferred embodiments of the invention, examples of which are illustrated in the accompanying drawings. The methods and system disclosed provide a new and useful data storage utility. Camcorder devices are present in many homes and contain a memory system, which until the present invention, have been limited in use to providing data storage for video images. The present invention utilizes these existing data storage systems to provide storage for a variety of data that may be provided by peripheral computing systems in communication with the camcorder.

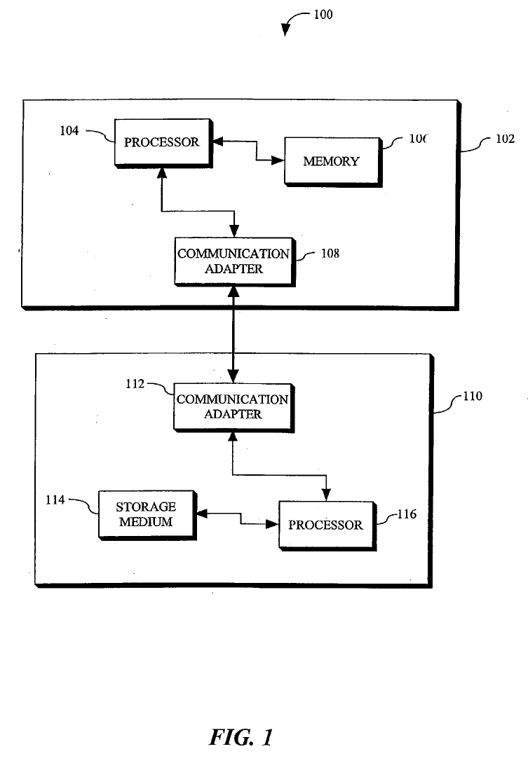

A block diagram of a system 100 for storing data is shown in FIG. 1. The system 100 includes a computing system 102 communicatively coupled with a camcorder 110. In the present embodiment the camcorder 110 is a digital camcorder, however, it is understood that the camcorder 110 may vary in design as contemplated by one of ordinary skill in the art.

In the current embodiment, the computing system 102 is a personal computer (PC). Alternatively, the computing system 102 may be a variety of devices with the capability to receive, store, and transmit data, such as a video system, an analog tape system, an appliance, a television system, and the like. The computing system 102 includes a processor 104 coupled to a memory 106 and a communication adapter 108. The processor 104 executes the programs (instruction sets) stored in the memory 106 and then transmits those programs and data to the camcorder 110 via the communication adapter 108.

In the current embodiment, the camcorder 110 includes a communication adapter 112 coupled to a processor 116. The processor 116 is coupled to a storage medium 114. The communication adapter 112 receives the instruction set and data from a peripheral source, such as the computing system 102. The processor 116 directs the data to the storage medium 114 for storage. The storage medium 114, may be a variety of storage media, such as a tape, a flash media device (i.e., flash cards, memory sticks), a writeable compact disc, a writeable digital video disc, a floppy disk, a hard disk, or the like, without departing from the scope and spirit of the present invention. It is understood that the camcorder 110 may provide (read) or receive (write) analog or digital signals for communication between the camcorder 110 and peripheral systems, such as the computing system 102, and other external devices, networks, information sources, and the like.

Preferably, the communication interface between the camcorder 110 the computing system 102 may be established using a variety of systems, such as an IEE1394 port assembly, a serial port assembly, a parallel port assembly, a Small Computer System Interface (SCSI) port assembly, a Universal Serial Bus (USB) port assembly, an infrared assembly, a radio frequency assembly, and the like.

The dual functionality of the camcorder 110 as a tape backup device and an audio/video recording device may provide a consumer the benefit of cost savings and increased ease of use. Further, the consumer who before the present invention may have been unable to protect information with a tape backup has the option made available to them. It is understood that the present invention may be employed with a variety of computing devices without departing from the scope and spirit of the present invention.

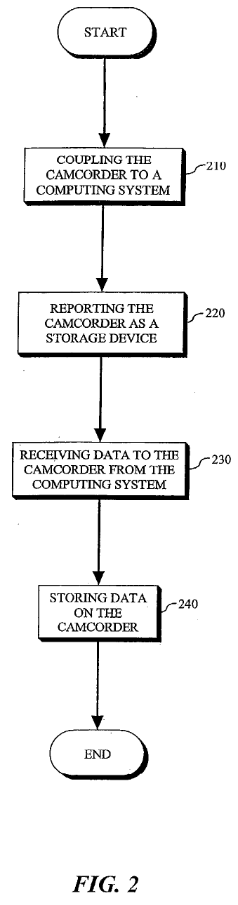

Referring now to FIG. 2 a flowchart illustrating functional steps that may be accomplished by the present invention, are shown. The method described by the FIG. 1 assumes that a user wishes to store information on a camcorder. Preferably, the camcorder is a digital camcorder but it is understood that a variety of camcorder devices may be employed without departing from the scope and spirit of the present invention. In step 210 the camcorder is coupled with a computing system. This coupling allows the computing system to communicate with the camcorder. The communicative link, as discussed in FIG. 1, may be established using a variety of systems, such as an IEE1394 port assembly, a serial port assembly, a parallel port assembly, a Small Computer System Interface (SCSI) port assembly, a Universal Serial Bus (USB) port assembly, an infrared assembly, a radio frequency assembly, and the like.

In step 220 the camcorder is directed to report as a storage device. This may be accomplished by a computer readable instruction set loaded into the processor of the camcorder. The instruction set allows the camcorder to receive data for storage from peripheral sources. The instruction set may direct the camcorder to interpret all incoming data as video data (i.e., normal operation) or to store data directly (i.e., tape backup operation). Further, the instruction set may be specific to the camcorder within which it is loaded or it may be a generic instruction set implemented as a device driver on a computing system which may be used with a variety of camcorders. Other methods than loading an instruction set into the processor of the camcorder, as may be contemplated by one of ordinary skill in the art, may be employed.

In step 230 the camcorder receives data from the computing system. The computing system may send a variety of data, such as video data, non-video data, and the like. This ability to receive a variety of data types may increase camcorder utility in that the user may be able to use the camcorder across a multiplicity of tasks. With the communicative coupling, as described previously, the camcorder may serve as a reliable data back up device in a myriad of environments. Thus the user may be on a vacation, such as an African safari, and be able to receive and store vital information on the camcorder, eliminating the need for surplus devices.

The storing of the data on the camcorder, step 240, occurs within the storage medium used by the camcorder. The storage medium may be a variety of media, such as a tape, a flash media device (i.e., flash cards, memory sticks), a writeable compact disc, a writeable digital video disc, a floppy disk, a hard disk, or the like, without departing from the scope and spirit of the present invention. By employing the storage medium of the camcorder to store data received from the peripheral computing system source the user is presented with a cost and space efficient method for increasing data storage capabilities.

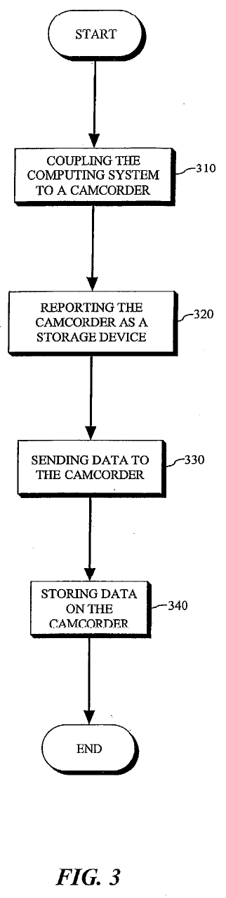

A method of storing data provided by a computing system is shown in FIG. 3. In step 310 the computing system is coupled to a camcorder. Preferably, the camcorder is a digital camcorder, however, a variety of camcorder systems, as contemplated by one of ordinary skill in the art may be employed. As described in FIG. 2, the coupling of the computing system to the camcorder establishes a communicative linkage. The communicative link may be enabled using a variety of systems as discussed previously.

With the communicative link established, the computing system in step 320 directs the camcorder to report as a storage device. The computing system may include an instruction set specific for the particular camcorder, which tells that camcorder to report as a storage device. Thus, the computing system may be limited to establishing only one specific camcorder type as a secondary storage facility. Alternatively, the computing system may be enabled with an instruction set that is able to direct a variety of camcorders (various models and brands) to report as storage devices. With this flexibility the computing system may interface with these different camcorders without having to load a separate instruction set for each different type.

Once the computing system has directed the camcorder to report as a storage device, in step 330 the computing system sends the data to the camcorder. When the camcorder is enabled with an instruction set which provides a storage device mode of operation, the data sent may be of any type. When the computing system is utilizing a device driver, the data may be re-formatted and sent to the camcorder as either a device-specific format suitable for direct media storage, or generic video data.

The camcorder in step 340 stores the data received from the computing system in the storage medium of the camcorder. As described in FIG. 2 the storage medium may be a variety of media, such as a tape, a flash media device (i.e., flash cards, memory sticks), a writeable compact disc, a writeable digital video disc, a floppy disk, a hard disk, or the like, without departing from the scope and spirit of the present invention.

By providing an instruction set which is loaded into the computing system as a device driver and enables a variety of camcorders as storage devices a user may be able to save significant costs. A single instruction set that loads into any computing system may keep costs lower, thus keeping the consumers costs lower.

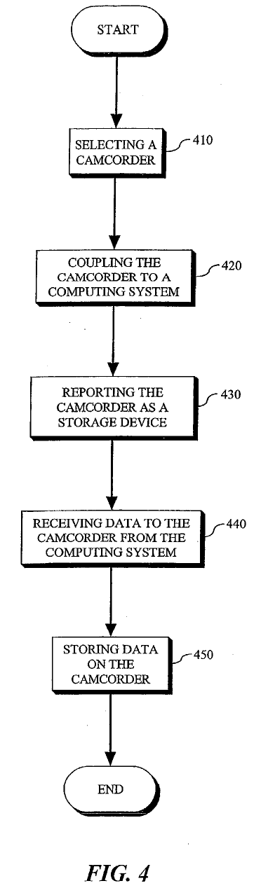

Referring now to FIG. 4, a method of storing data is shown. In step 410 a user selects a camcorder. Preferably, the camcorder is a digital camcorder. However, a variety of camcorders may be employed without departing from the scope and spirit of the present invention. After the camcorder is selected, in step 420 the camcorder is coupled to a computing system. The coupling establishes a communicative linkage and may use a variety of communicative linkage systems as described in previous FIGS. 1 through 3.

In step 430 the camcorder is directed to report as a storage device. This may be accomplished in a variety of ways as described previously in FIGS. 2 and 3. For example, the camcorder may have been loaded with an instruction set directing it to report as a storage device. Alternately, the computing system may have been loaded with the instruction set as a device driver which reports the camcorder as a storage device to the applications running on the computing systems. It is understood that the instruction set may be specific to the particular camcorder selected or the instruction set may be applicable to a variety of camcorders. In step 440 data is received by the camcorder from the computing system. The type of data received may vary and the form in which the data is presented to the camcorder may vary as described above in FIGS. 2 and 3.

In step 450 the data received by the camcorder is stored in the camcorder storage medium. The storage medium may be a variety of storage media as has been previously described in FIGS. 2 and 3.

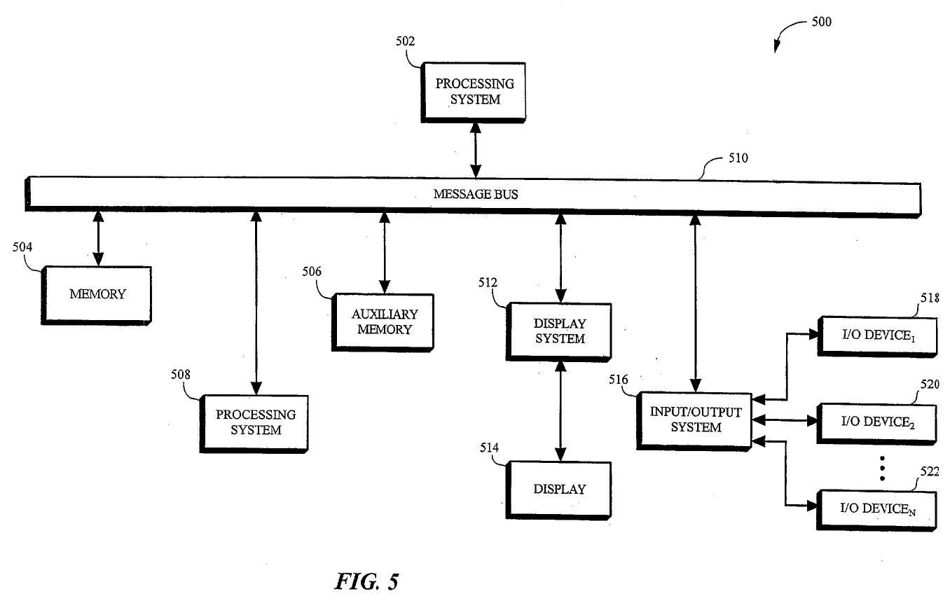

FIG. 5 illustrates an exemplary computing system 500 which may be employed in the present invention. It is contemplated that the camcorder employed in the present invention may be enabled as a computing system and includes similar features as those shown and described here.

The computing system 500 (hardware system) is controlled by a central processing system 502. The central processing system 502 includes a central processing unit such as a microprocessor or microcontroller for executing programs, performing data manipulations and controlling the tasks of the computing system 500. Communication with the central processor is implemented through a system bus 510 for transferring information among the components of the computing system. The bus may include a data channel for facilitating information transfer between storage and other peripheral components of the computing system. The bus 510 further provides the set of signals required for communication with the central processing system 502 including a data bus, address bus, and control bus. The bus 510 may comprise a state of the art bus architecture according to promulgated standards, for example, industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Other components of the computing system 500 include main memory 504 and auxiliary memory 506. The computing system 500 may further include an auxiliary processing system 508 as required. The main memory 504 provides storage of instructions and data for programs executing on the central processing system 502. The main memory 504 is typically semiconductor-based memory such as dynamic random access memory (DRAM) and/or static random access memory (SRAM). Other semi-conductor-based memory types include, for example, synchronous dynamic random access memory (SDRAM), Rambus dynamic random access memory (RDRAM), ferroelectric random access memory (FRAM), and so on.

The auxiliary memory 506 provides storage of instructions and data that are loaded into the main memory 504 before execution. The auxiliary memory 506 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 364 may also include a variety of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well.

The computing system 500 may optionally include an auxiliary processing system 508 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It will be recognized that such auxiliary processors may be discrete processors or may be built in to the main processor.

The computing system 500 includes the display system 512 for connecting to a display device 514, and an input/output (I/O) system 516 for connecting to one or more I/O devices 518, 520, and up to N number of I/O devices 522. The display system 512 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like. The display device 514 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth.

The input/output system 516 may comprise one or more controllers or adapters for providing interface functions between the one or more I/O devices 518-522. For example, the input/output system 516 may comprise an IEE1394 port, a serial port, parallel port, universal serial bus (USB) port, infrared port, network adapter, printer adapter, radio-frequency (RF) communications adapter, universal asynchronous receiver-transmitter (UART) port, etc., for interfacing between corresponding I/O devices such as a keyboard, mouse, trackball, touchpad, joystick, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, another information handling system, etc.

It is understood that the input/output system 516 and I/O devices 518-522 may provide or receive analog or digital signals for communication between the computing system 500 of the present invention and external devices, networks, or information sources. The input/output system 516 and I/O devices 518-522 preferably implement industry promulgated architecture standards, including Ethernet IEEE 360 standards (e.g., IEEE 360.3 for broadband and baseband networks, IEEE 360.3z for Gigabit Ethernet, IEEE 360.4 for token passing bus networks, IEEE 360.5 for token ring networks, IEEE 360.6 for metropolitan area networks, and so on), Fibre Channel, digital subscriber line (DSL), asymmetric digital subscriber line (ASDL), frame relay, integrated digital services network (ISDN), personal communications services (PCS), transmission control protocol/Internet protocol (TCP/IP), serial line Internet protocol/point to point protocol (SLIP/PPP), and so on. It is appreciated that modification or reconfiguration of the computing system 500 of FIG. 5 by one having ordinary skill in the art does not depart from the scope or the spirit of the present invention.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the system and method for storing data in a camcorder of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A data storage system, comprising:
a camcorder including a storage medium;
a computing system in communication with the camcorder, the computing system being suitable for providing data; and
a computer readable instruction set reporting the camcorder as a storage device,
wherein the camcorder stores data received from the computing system in the storage medium.

2. The data storage system of claim 1, wherein the camcorder is a digital camcorder.

3. The data storage system of claim 1, wherein the camcorder is enabled to read data to peripheral systems.

4. The data storage system of claim 1, wherein coupling the camcorder with the computing system is enabled by at least one of an IEE1394 port assembly, a serial port assembly and a parallel port assembly.

5. The data storage system of claim 1, wherein directing the camcorder to report as a storage device is enabled by an instruction set included within the camcorder.

6. The data storage system of claim 1, wherein the instruction set is included within the computing system and reformats the data as at least one of video data and a device-specific data format.

7. The data storage system of claim 5, wherein the instruction set is at least one of specific for the camcorder and generic for providing the instruction set to a plurality of camcorders.

8. The data storage system of claim 1, wherein the storage medium is at least one of a tape, a flash media device, a writeable compact disc, a writeable digital video disc, a floppy disk, and a hard disk.

9. A method of storing data on a camcorder, comprising:
coupling the camcorder with a computing system, for enabling communication between the camcorder and the computing system;
reporting the camcorder as a storage device;
receiving data from the computing system; and
storing the data to the camcorder.

10. The method of claim 9, wherein the camcorder is a digital camcorder.

11. The method of claim 9, wherein the camcorder is enabled to read data to peripheral systems.

12. The method of claim 9, wherein coupling the camcorder with the computing system is enabled by at least one of an IEE1394 port assembly, a serial port assembly, and a parallel port assembly.

13. The method of claim 9, wherein directing the camcorder to report as a storage device is enabled by an instruction set included within the camcorder.

14. The method of claim 12, wherein the instruction set is included within the computing system and reformats the data as at least one of video data and a device-specific data format.

15. The method of claim 12, wherein the instruction set is at least one of specific for the camcorder and generic for providing the instruction set to a plurality of camcorders.

16. The method of claim 9, wherein storing the data is enabled by a storage medium coupled with the camcorder.

17. The method of claim 15, wherein the storage medium is at least one of a tape, a flash media device, a writeable compact disc, a writeable digital video disc, a floppy disk, and a hard disk.

18. A method of storing data provided by a computing system, comprising:
coupling the computing system with a camcorder, for enabling communication between the camcorder and the computing system;
reporting the camcorder as a storage device;
sending data to the camcorder; and
storing the data to a storage medium of the camcorder.

19. The method of claim 18, wherein the camcorder is a digital camcorder.

20. The method of claim 18, wherein the camcorder is enabled to read data to peripheral systems.

21. The method of claim 18, wherein coupling the camcorder with the computing system is enabled by at least one of an IEE1394 port assembly, a serial port assembly, and a parallel port assembly.

22. The method of claim 18, wherein directing the camcorder to report as a storage device is enabled by an instruction set included within the camcorder.

23. The method of claim 21, wherein the instruction set is included within the computing system and reformats the data as at least one of video data and a device-specific data format.

24. The method of claim 21, wherein the instruction set is at least one of specific for the camcorder and generic for providing the instruction set to a plurality of camcorders.

25. The method of claim 18, wherein the storage medium is at least one of a tape, a flash media device, a writeable compact disc, a writeable digital video disc, a floppy disk, and a hard disk.

26. A method of storing data, comprising:
selecting a camcorder including a storage medium;
coupling the camcorder with a computing system, for enabling communication between the camcorder and the computing system;
reporting the camcorder as a storage device;
receiving data to the camcorder from the computing system; and
storing data to the storage medium of the camcorder.

27. The method of claim 26, wherein the camcorder is a digital camcorder.

28. The method of claim 26, wherein the camcorder is enabled to read data to peripheral systems.

29. The method of claim 26, wherein coupling the camcorder with the computing system is enabled by at least one of an IEE1394 port assembly, a serial port assembly, and a parallel port assembly.

30. The method of claim 26, wherein directing the camcorder to report as a storage device is enabled by an instruction set included within the camcorder and the computing system.

31. The method of claim 30, wherein the instruction set is included within the computing system and reformats the data as at least one of video data and a device-specific data format.

32. The method of claim 30, wherein the instruction set is at least one of specific for the camcorder and generic for providing the instruction set to a plurality of camcorders.

33. The method of claim 26, wherein the storage medium is at least one of a tape, a flash media device, a writeable compact disc, a writeable digital video disc, a floppy disk, and a hard disk.

34. A data storage system, comprising:
means for a storage device;
means for sending data to the storage device means; and
means for storing data on the storage device means.

35. The data storage system of claim 34, wherein the means for a storage device comprises a camcorder including a storage medium.

36. The data storage system of claim 35, wherein the camcorder is a digital camcorder.

37. The data storage system of claim 36, wherein the camcorder is reported as a storage device.

38. The data storage system of claim 37, wherein the camcorder stores data received having been reformatted as video data.

39. The data storage system of claim 34, wherein the camcorder is enabled to read data to peripheral systems.

40. The data storage system of claim 34, wherein the means for sending data further comprises a computing system coupled to the camcorder, the computing system is enabled to send data to the camcorder by at least one of an IEE1394 port assembly, a serial port assembly, and a parallel port assembly.

41. The data storage system of claim 34, wherein the means for storing data includes at least one of a tape, a flash media device, a writeable compact disc, a writeable digital video disc, a floppy disk, and a hard disk, coupled with the camcorder.
